(19) United States
(12) Patent Application Publication
(10) Pub. No.: US 2023/0344897 A1
(43) Pub. Date: Oct. 26, 2023

(54) SYSTEMS AND METHODS FOR DYNAMIC METADATA GENERATION FOR CLOUD SERVICE INTEGRATION

(71) Applicant: HUAWEI CLOUD COMPUTING TECHNOLOGIES CO., LTD., Gui'an New District (CN)

(72) Inventors: Jin Rong LUO, Kanata (CA); Eugene CHAN, Kanata (CA); Ming CHEN, Kanata (CA); Reji MATHEWS, Kanata (CA); Qimeng WEI, Shenzhen (CN); Guanglin LV, Shenzhen (CN)

(21) Appl. No.: 18/345,609

(22) Filed: Jun. 30, 2023

Related U.S. Application Data
(63) Continuation of application No. PCT/CN2020/141915, filed on Dec. 31, 2020.

(51) Int. Cl. H04L 67/10

(52) U.S. Cl. CPC H04L 67/10

(57) ABSTRACT

Methods and systems for cloud computing service integration with an end-user application are described. The methods receive connection information necessary to connect to a cloud platform, the cloud platform being an architecture hosting the cloud computing services, and request, at runtime by submitting the connection information to the cloud platform, endpoint information of one or more components hosted by the cloud platform. The methods then receive, from the cloud platform, in response to the submitted connection information, endpoint information of the one or more components hosted by the cloud platform. The endpoint information includes at least parameters required to invoke the one or more components. The methods also generate metadata for each component of the one or more components, the metadata of each component comprising endpoint information enabling the end-user application to invoke the respective component of the cloud platform. The systems are configured to implement the described methods.

### RELATED APPLICATIONS

This application is a continuation of International Patent Application No. PCT/CN2020/141915, filed Dec. 31, 2020, the contents of which are incorporated herein by reference.

### TECHNICAL FIELD

Example embodiments relate to cloud computing, and in particular, to dynamic metadata generation for cloud service integration.

### BACKGROUND

Cloud computing is a form of network-based computing that enables access to shared pools of configurable computing resources and higher-level services that can be rapidly provisioned with minimal management effort, typically accessible for use by clients over the Internet. Cloud computing, delivered through cloud computing architecture (referred to hereinafter as the cloud platform), relates to client-server based computing that is implemented as services. Cloud computing service providers generally deliver three main types of services (referred to hereinafter as cloud computing services), infrastructure as a service (IaaS), platform as a service (PaaS), and software as a service (SaaS), by creating virtual machines and containers on demand for use by clients. IaaS provides a computing infrastructure that can be rented and used by clients. The computing infrastructure comprises physical computing components and resources (e.g. processors, memory, storage, servers, networking components, etc.) that are virtualized and shared among clients. PaaS provides a platform that allows clients to develop, run, and manage software applications without having to build and maintain the computing infrastructure and middleware. SaaS provides software applications running on the computing infrastructure on demand over the Internet on a subscription basis. Each service of the cloud computing services of the cloud platform has multiple components to be utilized by clients.

End-user applications, which are client applications, are connected to components of cloud computing services of the cloud platform (referred to herein as the components of the cloud platform) through connection endpoints. These applications could be external, such as on-premise applications or cloud applications hosted by the cloud platform. The connection endpoints are defined by the cloud platform provider. Information of the connection endpoints (referred to hereinafter as endpoint information) is needed to access components of the cloud platform. Endpoint information includes connection protocol, component address, component parameters, and other parameters. An end-user application, which desires to use components of the cloud platform, must have access to endpoint information to establish a connection. Collecting, updating, and maintaining endpoint information may become expensive, depending on the number of components maintained. Specifically, inefficiencies arise when new components are hosted by the cloud platform or the parameters of the components are changed. An end-user application with access to inaccurate endpoint information may be unstable. Also, the end-user application may not utilize the cloud platform’s components to its full capability.

Existing solutions lack the capability to update endpoint information and discover new components dynamically. Therefore, there is a need for methods and systems to determine endpoint information of the components hosted by a cloud platform, update the endpoint information of the components if changed, and discover new components when added.

### SUMMARY

The present disclosure describes methods and systems for an integration module that dynamically generates metadata at runtime. The integration module also applies a set of rules that may reduce the number of parameters required from the end-user applications in at least some scenarios. Generating metadata at runtime can discover new components added to the cloud platform and update the endpoint information of previously discovered components if modified or changed.

An example embodiment of the present disclosure is a method for integrating one or more components of cloud computing services with an end-user application. The method receives connection information necessary to connect to a cloud platform, the cloud platform being an architecture hosting the cloud computing services, and requests, at runtime by submitting the connection information to the cloud platform, endpoint information of one or more components hosted by the cloud platform. After submitting the request, the method receives, from the cloud platform, in response to the submitted connection information, endpoint information of the one or more components hosted by the cloud platform, the endpoint information includes at least parameters required to invoke (colloquially, to call upon) the one or more components. Lastly, the method generates metadata for each component of the one or more components, the metadata of each component comprising endpoint information enabling the end-user application to invoke the respective component of the cloud platform.

In an example, the method further applies rules to the generated metadata to reduce the number of parameters required from the end-user application to invoke the one or more components. One type of rules is an override rule. For this rule, the method identifies, from the generated metadata, a common label, the common label being parameters of the same label. Afterwards, the method requests one instance of the common label from the end-user application. The override rule is configured to copy data of the parameter of the one instance of the common label into all parameters of the common label.

In some examples of the foregoing aspects, the method further applies a dependency rule. For the dependency rule, the method identifies, from the generated metadata, dependency relationship between a first component and a second component, the first component being dependent on the second component. The dependency rule is configured to request one or more parameters from the end-user application to invoke the second component only if the one or more parameters of the first component are being requested.

In some examples of the foregoing aspects, the method is repeated at any instance requested by the end-user application, generating metadata and discovering endpoint information changes of the one or more components.

In some examples of the forgoing aspects, the connection information submitted to the cloud platform are submitted with appending information to indicate (and thereby limit) the type and scope of information being requested.

In some examples of the forgoing aspects, the end-user application using the method is a cloud platform application. In some examples, the end-user application using the method is an on-premise application in a processing device.

In some examples of the forgoing aspects, the method requests from the end-user application the parameters detailed in the generated metadata to invoke the respective one or more components. The method then validates the parameters received from the end-user application against the generated metadata for compliance.

In some examples of the foregoing aspects, the generated metadata is organized in a JavaScript Object Notation (JSON) format.

According to example aspects, systems are disclosed that are configured to perform the methods of one or more of the above aspects.

According to example aspects, non-transitory computer-readable mediums are disclosed that are configured to perform the method of one or more of the above aspects.

### BRIEF DESCRIPTION OF THE DRAWINGS

For a more complete understanding of example embodiments and the advantages thereof, reference is now made to the following description taken in conjunction with the accompanying drawings, in which:

FIG. 1 is a block diagram illustrating an example cloud computing system, in accordance with an example embodiment;

FIG. 2 is a block diagram illustrating an end-user processing device interacting with the cloud computing system of FIG. 1, the end-user processing device including an end-user application with an integration module, in accordance with an example embodiment;

FIG. 3 is a block diagram illustrating the operation of an integration module, in accordance with an example embodiment;

FIG. 4 shows metadata of a connection request in JSON format including connection information and appending information submitted to a cloud platform, in accordance with an example embodiment of the present disclosure;

FIG. 5 shows the metadata response from a cloud platform for submitting the metadata of connection request in FIG. 4, in accordance with an example embodiment;

FIG. 6A is a pseudocode metadata example of an override rule of metadata governance, in accordance with an example embodiment;

FIG. 6B is a pseudocode metadata example of a dependency rule of metadata governance, in accordance with an example embodiment;

FIG. 7A is a block diagram illustrating an example of dependency relationships between three components of the cloud platform, in accordance with an example embodiment;

FIG. 7B is another block diagram illustrating an example of dependency relationships between three components of the cloud platform, in accordance with an example embodiment;

FIG. 8 is a flowchart of a method for generating metadata using a metadata generator, in accordance with an example embodiment; and

FIG. 9 is a flowchart of a method performed by an integration module, in accordance with an example embodiment.

Similar reference numerals may have been used in different figures to denote similar components.

### DETAILED DESCRIPTION

An end-user application may need to integrate various components hosted by a cloud platform to provide the desired outcomes. These components are developed, packaged and deployed on one or more cloud platforms. Usually, cloud platform providers provides connection information, which is instructions for end-user applications to connect to the cloud platform and discover the hosted components. Such connection information may be deemed necessary to connect to a cloud platform, that is, it is the information that is needed to connect (and that may vary, e.g., from platform to platform). Available solutions discover components hosted by a cloud platform and store endpoint information, which is instructions to connect to each component of the cloud platform 100, in memory and does not change it. Endpoint information may include connection protocol, component address, and component parameters to be used by the end-user application to connect to the respective component of the cloud platform. Since the endpoint information are stored in memory and not updated, these solutions may fail if cloud platform providers change the endpoint information of the components. The end-user application may also be unaware of new components hosted by the cloud platform after the end-user application has connected to the cloud platform and stored its components’ endpoint information.

Example embodiments of the present disclosure describe systems and methods for generating metadata, comprising endpoint information of components, and applying rules to the metadata to reduce the number of parameters requested from the end-user application. The methods and systems may also validate the end-user application’s parameters for compliance with the parameters expected by the components. These parameters requested from the end-user application are required to invoke respective components of the cloud platform. For at least one or a combination of thereof, the methods and systems of the present disclosure may generate metadata, apply rules, and validate parameter at runtime. Generating the metadata at runtime allows the methods and systems to continuously discover any components’ endpoint information changes and discover newly hosted components.

Metadata is a type of data that provides information about other data. It could be a form of a summary that may include a method to create the other data, and provide dates on when the other data was created, which computer internet protocol was used to create the other data, the size of the other data, and additional information. The metadata of the present disclosure includes various information enabling connection to a cloud platform and its components. Metadata of the present disclosure comprises, at least one of, uniform resource identifier (URI), the method to submit the metadata, e.g., “get” or “post”, the authentication method, e.g. session-based authentication or token-based authentication, and parameters to invoke one or more components of the cloud platform. Each component has a specific metadata set, and all sets of metadata are compiled into a metadata file stored in memory. Metadata in this disclosure is a means to implement policies, trigger actions, and provide endpoint information to connect to components of a cloud platform.

For compatibility across platforms, metadata is usually formatted using a well-defined structure such as JavaScript Object Notation (JSON) or Extensible Markup Language (XML). The metadata is determined at runtime through a discovery process by submitting a metadata of connection request comprising the connection information to the cloud platform, and receiving, in response to the metadata of connection request, endpoint information of the components hosted by the cloud platform.

The generated metadata is dynamic because it is generated when the end-user application needs to invoke a component. Hence, the endpoint information is collected at runtime. If there are any endpoint information changes, the metadata will be updated accordingly.

Example embodiments of the present disclosure also describe a method for imposing or applying rules to reduce the number of parameters requested from the end-user application. Some components have common labels, where a label is a string placeholder of a respective parameter required to invoke one or more component of the cloud platform. An example of a label is “ID,” and its parameter may be an alphanumerical string of “abc123”. The method identifies common labels and provides instructions to override the common labels’ parameters by copying their values from one instance of each common label. The parameter of the one instance of each common label is requested from the end-user application. As a result, the method requests from the end-user application one instance for each common label instead of requesting it multiple times if multiple components require the same label.

For example, if multiple components require a parameter for a label “ID”, then the method identifies the common label “ID”, and requests its parameter once from the end-user application. The method overrides all parameters of label “ID” and provides instructions to copy their data from the parameter requested from the end-user application.

In example embodiments, a method identifies dependencies between components and sets rules to reduce the number of parameters requested from the end-user application. For example, some scenarios require invoking a first component that depends on invoking a second component. Suppose the end-user application does not invoke the first component. In that case, the method identifies the dependency and provides instructions not to request parameters to invoke the second component, reducing the number of parameters requested from the end-user application.

The following embodiments and aspects thereof are described and illustrated in conjunction with systems, tools and methods which are meant to be exemplary and illustrative, not limiting in scope. In various embodiments, one or more of above-described challenges have been reduced or eliminated, while other embodiments are directed to other improvements.

Embodiments will now be described more fully hereinafter with reference to the accompanying drawings, in which some, but not all, embodiments of the invention are shown. The features and aspects presented in this disclosure may be embodied in many different forms and should not be construed as limited to the embodiments set forth herein. Where possible, any terms expressed in the singular form herein are meant to also include the plural form and vice versa, unless explicitly stated otherwise. In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

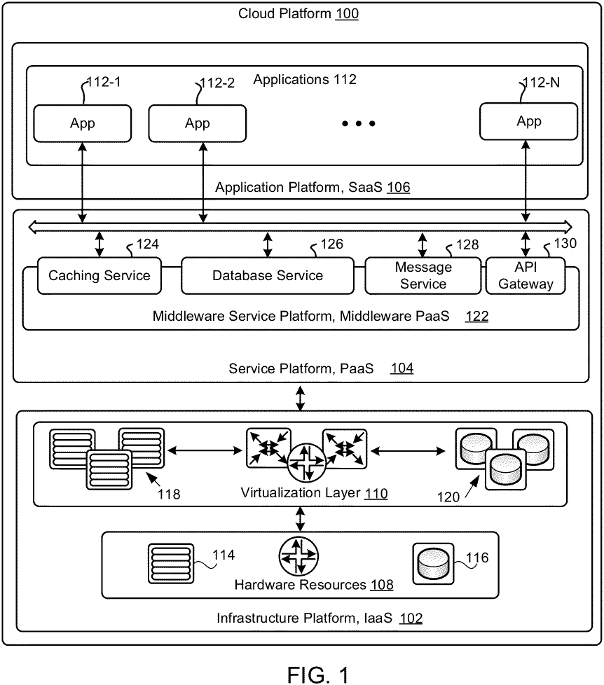

FIG. 1 is a logical block diagram illustrating a cloud computing architecture of a cloud computing system that can deliver cloud computing services. The illustrated logical diagram of the cloud computing architecture 100 (the cloud platform 100) generally comprises an infrastructure platform 102 (e.g. IaaS layer), a service platform 104 (e.g. PaaS layer), and an application platform 106 (e.g., SaaS layer), each of which include a respective set of components. The infrastructure platform 102 comprises components including the physical hardware resources 108, and a virtualization layer 110 that presents an abstraction of the physical hardware resources 108 to the service platform 104 and the application platform 106. The physical hardware resources 108 include components such as physical machines 114 that include processing resources (e.g., central processing units (CPUs), graphic processing units (GPUs), accelerators, tensor processing units (TPUs)), physical storage 116 that include storage resources such as memory (e.g., static random access memory (SRAM), dynamic random access memory (DRAM), synchronous DRAM (SDRAM), read-only memory (ROM), persistent storage devices (e.g. hard disk drives, optical drives, ) or a combination thereof), and networking resources (not shown) that are generally resident within a data center. A data center, as will be understood in the art, includes a collection of the physical hardware resources 108 (typically in the form of servers) that can be used as a collective computing resource comprising processing, storage, and networking resources. Within a data center, a plurality of servers can be connected together to provide a computing resource pool upon which virtualized entities can be instantiated. Data centers can be interconnected with each other to form pools of computing resources connected to each by connectivity resources. The connectivity resources may take the form of physical connections such as Ethernet or optical communications link.

The virtualization layer 110 supports a flexible and efficient multi-tenancy run-time and hosting environment for the applications 112 that are components of the application platform 106, which is a collection of multiple applications 112-1, 112-2, ... 112-N, by providing the infrastructure platform 102 facilities. The application platform 106 provides software applications 112-1, 112-2, ... 112-N running on components of the infrastructure platform 102 for use by other end-users or end-user applications. The virtualization layer 110 includes a virtualization manager or hypervisor (not shown) that may provide a security and resource “sandbox” for each application 112-1, 112-2, ..., 112-N. Each “sandbox” may be implemented as a Virtual Machine (VM) 118 that may include an appropriate operating system and controlled access to virtualized storage resources 120.

The virtualization of the physical hardware resources 108 by the virtualization layer 110 is considered a foundational technology for the cloud platform 100. Virtualization is a technology that allows for the creation of virtual computing resource pools of computing resources (e.g., processing, storage, and networking resources) connected to each by connectivity resources. Virtualization may take the form of instantiating VMs 118 that, to another entity on a network and to software executed on the VM 118, is no different than a physical computing device. A VM 118 has its own set of computing resources (e.g. processing, storage, and connectivity resources), upon which an operating system can be executed. The VM 118 can have a virtual network interface that can be assigned a network address. Between the underlying resources and the VM 118, there is typically a hypervisor (not shown) that manages the resource isolation and network interactions. One of the purposes of a VM 118 is to provide isolation from other processes running on the cloud platform 100. When initially developed, a VM 118 was a mechanism to allow different processes to operate without concern that a single errant process would be able to cause a complete system crash. Instead, an errant process would be contained to its own VM 118. This isolation allows for each VM 118 to have its own set of network interfaces. Typically, a single underlying computing resource can support a plurality of virtualized entities.

It will be appreciated by those skilled in the art that a more recent development has been the use of containers in place of VMs 118. As mentioned above, each VM 118 typically includes its own operating system, which typically increases redundant computing, storage, and connectivity resource usage. Containers allow a single OS kernel to support a number of isolated applications. In place of a hypervisor that allows each VM 118 to run its own OS, a single OS hosts containers that are responsible for enforcing the resource isolation that would otherwise be provided by the VM 118.

The service platform 104 provides the capabilities for hosting services including middleware service platform 122. The middleware service platform 122 provides a set of middleware services and infrastructure services to the applications (112-1, 112-2, ..., 112-N) hosted on the application platform 106. Applications 112 hosted on the application platform 106 may run on either the VMs 118 or the physical machines 114.

In the embodiment depicted in FIG. 1, the middleware service platform 122 includes components such as a cloud caching service system 124 for in-memory data storage, a database service 126 for applications, a message service 128 for publishing messages to subscriber customers, and an application program interface (API) gateway service 130 that enables end-users to create, publish, and maintain application program interfaces (APIs) to access other cloud components. It will be appreciated by those skilled in the art that the middleware service platform 122 may provide other middleware application services to end-users, such as notification services, run-time services, and the like. Applications 112 may be deployed and executed within a respective VM 118 or physical machine 114.

Accordingly, cloud platform 100 delivers three main types of services, namely infrastructure as a service (IaaS) supported by the infrastructure platform 102; platform as a service (PaaS) supported by the service platform 104, and software a service (SaaS) supported by the application platform 106. Each of these platforms includes the components noted above, and can be supported by the components of other platforms (e.g., applications 112 run on VMs 118 or physical machines 114). The following description provides a mechanism to access the components of the IaaS platform 102, the PaaS platform 104, and the SaaS platform 106 to enable functions provided by these components to be accessed by end user applications as described further below.

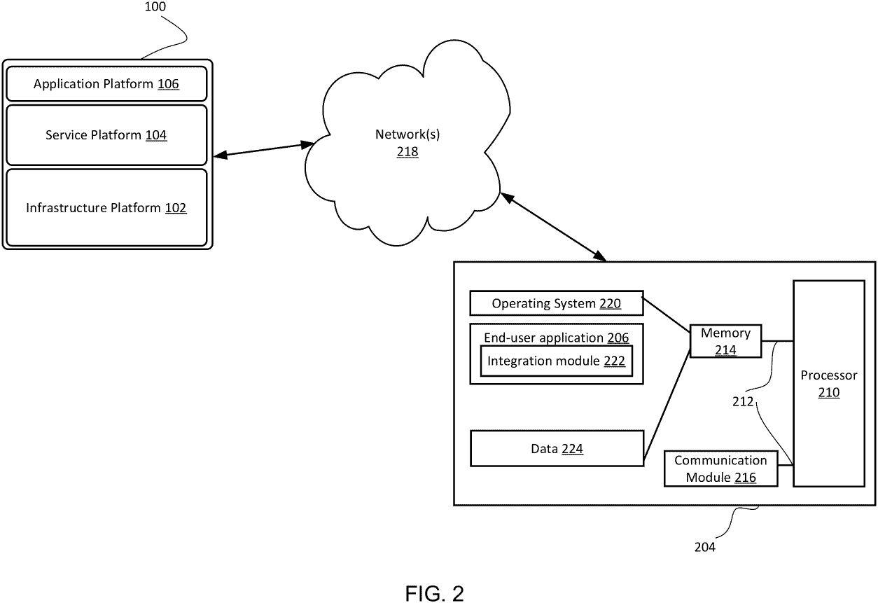

FIG. 2 is a block diagram illustrating an end-user application 206 with an integration module 222 in an end-user computing device 204 configured to connect to one or more components of the cloud platform 100, in accordance with an example embodiment. The computing device 204 comprises at least one processor 210, which controls the overall operation of the computing device 204. The processor 210 is coupled to a plurality of components via a communication bus 212, which provides a communication path between various components of the computing device 204 and the processor 210. The computing device 204 comprises memory 214 that can include Random Access Memory (RAM), Read-Only Memory (ROM), a persistent (non-volatile) memory which may one or more of a magnetic hard drive, flash erasable programmable read-only memory (EPROM) (“flash memory”) or other suitable forms of memory. The computing device 204 includes a communication module 216.

The communication module 216 may comprise any combination of a long-range wireless communication module, a short-range wireless communication module, or a wired communication module (e.g., Ethernet or the like) to facilitate communication through the communication network 218. Communication network 218 includes, for example, a cellular network and the Internet. The computing device 204 and the cloud platform 100 are configured to communicate with one another through the communication network 218. Operating system software 220 executed by the processor 210 may be stored in the persistent memory of memories 214. Memories 214 can also store application software instructions that, when executed by the processor 210, configure the processor 210 to implement one or more end-user applications 206. The software instructions for an end-user application 206 can include software instructions that configure the computing device 204 to implement an integration module 222 responsible for establishing a connection with components of cloud platform 100. As used here, an “application” and a “module” can refer to a combination of a hardware processing circuit (e.g., processor 210) and machine-readable instructions (software and/or firmware) executable on the hardware processing circuit. A hardware processing circuit can include any or some combination of a microprocessor, a core of a multi-core microprocessor, a microcontroller, a programmable integrated circuit, a programmable gate array, a digital signal processor, or another hardware processing circuit.

The end-user application 206 may require access to at least one component of the cloud platform 100. The end-user application 206 may be a user interface enabling end-users to survey, integrate, and access components of a one or more cloud platforms 100. For example, end-user application 206 could be a machine learning application that utilizes components of the cloud platform 100 for training purposes. Data 224 is a repository of stored data in the persistent memory of memories 214.

The integration module 222 is used by the end-user application 206 to facilitate connection to components of the cloud platform 100. In some examples, integration module 222 connects to the cloud platform 100 through the communication network 218 through the API gateway 130. It generates metadata ready for use by the end-user application 206 to connect to one or more components of the cloud platform 100. The metadata generated by the integration module 222 may include information needed to establish the connection, such as connection protocol, component address, component parameters, etc. The metadata generated by the integration module 222 may be generated at runtime. It is dynamic because it may be continuously generated and updated by the end-user application 206 request. In some scenarios, the metadata may be generated every time the end-user application 206 requests to use a component of cloud platform 100. The integration module 222 is configured to store data at data 224 for the end-user application 206 to use.

In the example of FIG. 2, end-user application 206 is hosted by an end-user computing device 204. However, in some examples, some or all of the functionality of the end-user application 206 could be hosted as one of the applications 112 included in application platform 106 of cloud platform 100. In such examples, a browser application or thin-client application could be implemented by end-user computing device 204 to access the end-user application 206 on the cloud platform 100.

Thus, an end-user application 206 can in some examples refer to a locally hosted application as depicted in the computer device 204 of FIG. 2 or a cloud platform-hosted application that is co-hosted with applications 112-1, 112-2, ..., or 112-N of the application platform 106.

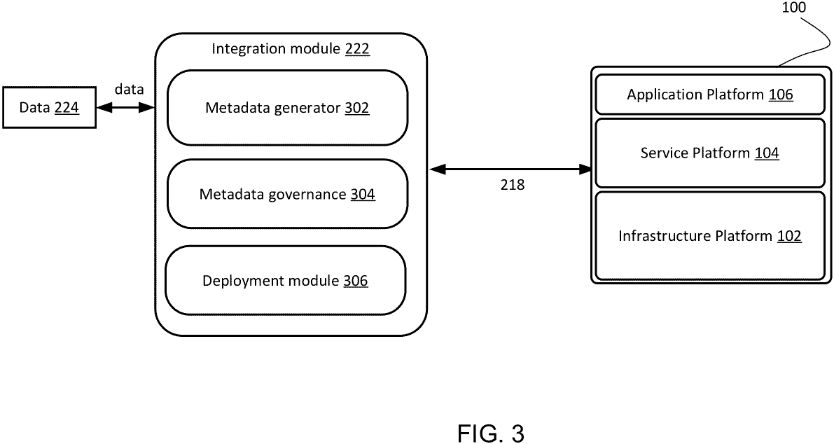

FIG. 3 is a block diagram illustrating the operation of integration module 222 of end-user application 206 and cloud platform 100, in accordance with an example embodiment of the present disclosure. The integration module 222 is configured to connect to one or more components of the cloud platform 100 through network 218. The purpose of the integration module 222 is to establish a connection between end-user application 206 and at least one component of the cloud platform 100. The integration module 222 consists of metadata generator 302, metadata governance 304, and deployment module 306.

Integration module 222 may enable end-user application 206 to connect to cloud platform 100 through the integration module 222. The integration module 222 may submits connection information through a connection request to the cloud platform 100. The connection information is provided by the cloud platform 100 provider. Cloud platform 100 providers do not usually change or modify the connection information. Further, connection information does not reveal any information about the components hosted by the cloud platform 100, endpoint information discussed below does. This structure is to allow the cloud platform provider make internal changes to cloud platform components without changing the connection information. The integration module 222 submits the connection information to the cloud platform 100, and in response, the cloud platform 100 returns endpoint information of the components hosted by the cloud platform 100.

Endpoint information is information received by the integration module 222 in response to submitting the connection information through a connection request. The endpoint information comprises information about the components hosted by the cloud platform 100 and how to connect to each component. Unlike connection information, cloud platform 100 providers may modify endpoint information of existing components or may add new components, hence new endpoint information, to the cloud platform 100.

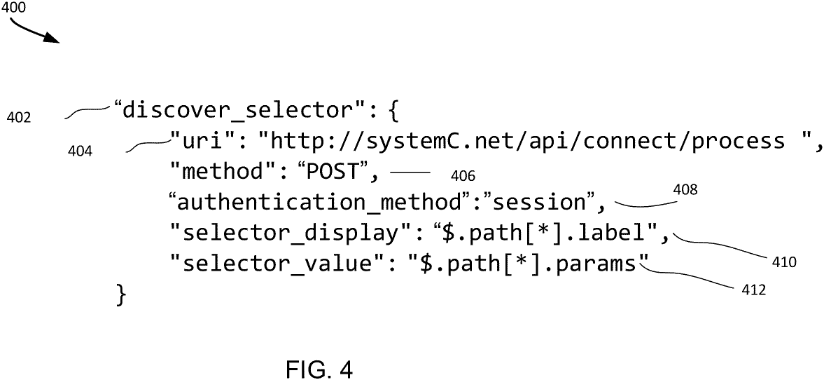

FIG. 4 shows metadata of a connection request 400 in JSON format including connection information and appending information submitted to cloud platform 100, in accordance with an example embodiment of the present disclosure. The metadata of a connection request 400, stored in data 224 (or corresponding cloud memory when the end-user application 206 is hosted on application platform 106 as a cloud application 100), titled “discover-selector” 402, includes connection information (URI 404, method 406, and authentication method 408), and appending information (“selector_display” 410 and “selector_value” 412). The connection information comprises resource identifier (URI) 404 indicating the address to access the cloud platform 100. It also includes the communication method as “post” 406, indicating that the connection request sent by the integration module 222 is to be accepted by the cloud platform 100. Further, it includes the authentication method 408 accepted by the cloud platform 100 to establish a connection. In this embodiment, “session” authentication method is required.

In addition to URI 402, method 404 and authentication 408, the metadata of connection request 400 can include appending information to indicate (and thereby limit) the type and scope of information that is being requested. In FIG. 4, the appending information fields indicate to the cloud platform 100 to send labels (“selector_display” 410) and parameters (“selector_value” 412) of the components. In response to submitting the metadata of the connection request 400, the cloud platform 100 returns endpoint information of all components hosted by the cloud platform and labels and parameters of each component. The parameters are data to be requested from the end-user application 206 to invoke the respective components, and the labels are string placeholders of the name of the parameters.

In some examples, the metadata of connection request may also include details to receive connection endpoint information of specific components of the cloud platform 100, instead of requesting endpoint information of all available components.

Referring to FIG. 3, the metadata generator 302 sends the connection request and generates the metadata required for the end-user application 206 to access at least one component of cloud platform 100. The metadata generation is performed by discovering the components hosted by the cloud platform 100 through submitting a connection request comprising at least connection information. In response to the connection request, the cloud platform 100 returns at least the endpoint information of one or more hosted components. The processor 210 (or the corresponding cloud processor when the end-user application 206 hosted on application platform 106 as a cloud application 100) stores the received metadata of the metadata generator 302 in data 224 (or corresponding cloud memory when the end-user application 206 hosted on application platform 106 as a cloud application 100). The metadata generator 302 generates a metadata set for each component discovered by the metadata generator 302. The metadata sets of all components are compiled into a metadata file stored in memory 224 (or corresponding cloud memory when the end-user application 206 hosted on application platform 106 as a cloud application 100).

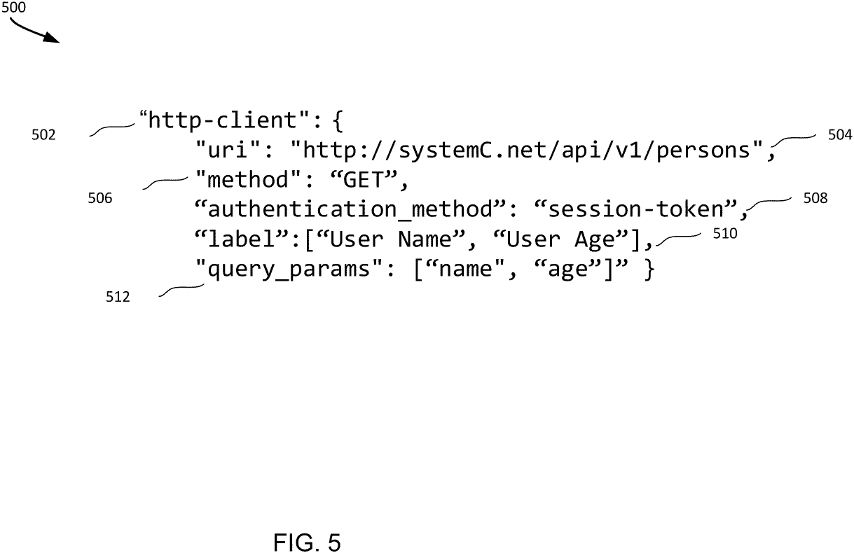

FIG. 5 shows a metadata response to a request by the metadata generator 302, in accordance with an example embodiment of the present disclosure. The metadata 500 is a response to the submitted metadata of the connection request of FIG. 4. The response is for of the hosted component “http-client” 502 of the cloud platform 100. FIG. 5 shows endpoint information of the component including (URI 504, method 506, and “authentication_method” 508) in response to the connection information (URI 404, method 406, “authentication_method” 408) of the metadata of connection request 402. FIG. 5 also shows returned label 510 and “query_params” 512 in response to the appending information (“selector_display” 410 and “selector_value” 412) of the metadata of connection request of FIG. 4.

To invoke the component “http-client” 502, end-user application 206 needs to connect to the specific component URI 504 through a “get” method. The “get” method is the opposite of the “post” method described above; it is a command to request resources from the cloud platform 100, in this embodiment from the “http-client” component. The end-user application 206 is required to authenticate using “session-token” authentication method 508.

The metadata of connection request in FIG. 4 includes appending information for labels and parameters. In response to “$.path[*].label” 410, the cloud platform 100 returned “User Name” and “User Age” 510, and in response to “$.path[*].params” 412, the cloud platform 100 returned “name” and “age” 512. The end-user application 206 needs to provide the parameters “name” and “age” 512 along with endpoint information (URI 504, method 506, and “authentication-_method” 508) to invoke the “http-client” 502 component. While FIG. 5 shows one component, multiple components may be returned. Each component has a metadata set including the endpoint information, labels, and parameters needed to invoke it.

In reference to FIG. 3, metadata governance 304 of the integration module 222 defines a set of rules to request from the end-user application 206 only the parameters required to invoke respective components successfully. The metadata governance appends the generated metadata with rules, when executed, request from the end-use application 206 the required input to invoke desired components of cloud platform 100. The rules of metadata governance 304 are stored with the metadata generated by metadata generator 302 in the metadata file in data 224 (or corresponding cloud memory when the end-user application 206 hosted on application platform 106 as a cloud application 100).

The integration module 222 requests, from the end-user application 206, the parameters required to invoke the desired components of cloud platform 100. In some embodiments, two or more components may require the same component label, e.g., a component label of “user name”, “ID”, “account number”, “e-mail address”, “age”, etc. Instead of requesting, from the end-user application 206, multiple parameters for the same label, the metadata governance 304 identifies the common label and requests its parameter value once. The metadata governance 304 populates the parameter values of the common label through an override rule. Hence, the metadata governance 304 reduces the number of parameters requested from the end-user application 206.

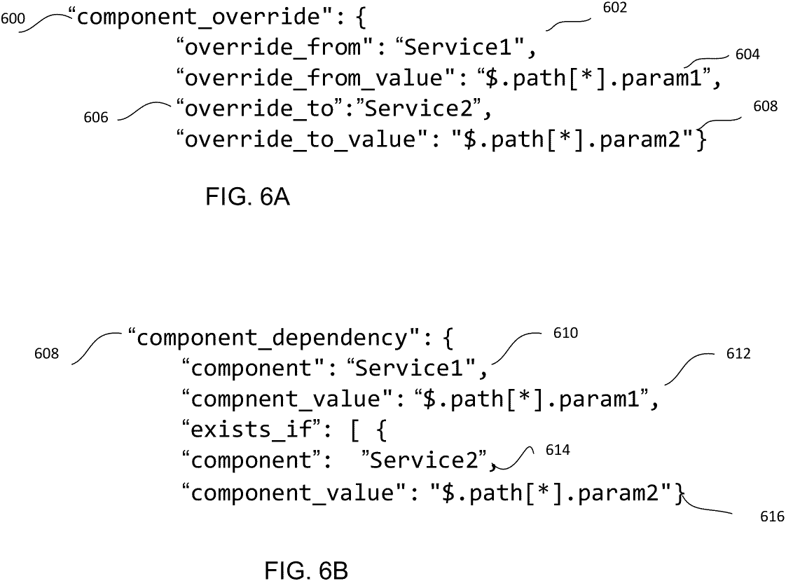

FIG. 6A is a pseudocode metadata example of an override rule generated by the metadata governance 304, in accordance with an example embodiment of the present disclosure. The metadata of the override rule, titled “component_override” 600, of the metadata governance 304 shows two components: Service1 602 and Service 2 606. Both components have the same label (a common label) with parameters “param1” 604 and “param2” 608. Instead of requesting from the end-user application 206 values for param1 604 and param2 608, the metadata governance 304 indicates to processor 210 (or the corresponding cloud processor when the end-user application 206 hosted on application platform 106 as a cloud application 100) to copy the data stored in param1 into param2. In other words, the metadata governance 304 sets rules to override the value of param2 608 and copy its value from param1 604 without requesting it from the end-use application 206.

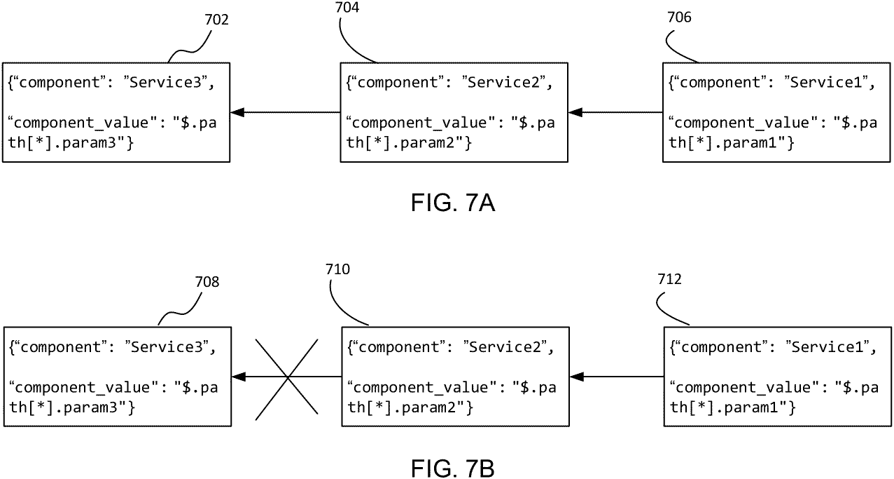

In another embodiment of the present disclosure, the metadata governance 304 identifies a dependency relationship between metadata sets. The metadata governance 304 ensures that if a parameter is requested from the end-user application 206, this parameter is used, hence, not redundant. Components are dependent in the sense that the existence of one component is dependent on the existence of another component. FIG. 7A is an example embodiment explaining the dependency relationships between three components of cloud platform 100: Service3 702, Service2 704, and Service1 706. Service2 704 depends on Service1 706, and Service3 702 depends on Service2 704. For Service3 to be invoked successfully, the end-user application 206 needs to provide param3 to invoke Service3 702, param2 to invoke Service 2 704, and param1 to invoke Service1 706.

FIG. 7B is another example embodiment explaining the dependency relationships between Service3 708, Service2 710, and Service1 712 of cloud platform 100. In this embodiment, Service3 708 does not depend on Service2 710; however, Service2 710 depends on Service1 712. In an example where end-user application 206 requires to invoke Service3, param3 708 is required from the end-user application 206, but Service2 710 and Service1 706 do not need to be invoked. Therefore, param2 of Service2 710 and param1 of Service1 712 are not required from the end-user application 206. Therefore, metadata governance 304 identifies param2 of Service2 710 and param1 of Service1 712 are not required and, upon execution of the generated metadata, the integration module 222 does not request their data from the end-user application 206.

FIG. 6B is a pseudocode metadata example of component dependency rule metadata generated by metadata governance 304 after identifying dependency between two components. The metadata of component dependency, titled “component_dependency” 608, generated by metadata governance 304 describes component dependency 608 between Service1 610 and Service2 614 of cloud platform 100. The metadata governance 304 implements rules defining the dependency between components, ensuring that a component of cloud platform 100 is invoked only when the components depending on it are needed to be invoked. The metadata of FIG. 6B describes param1 612 of Service1 610 is requested from the end-user application 206 only when param2 616 of Service2 614 is requested. This embodiment explains the dependency between Service2 614 and Service1 610. If Service2 614 is not invoked, Service1 610 does not need to be invoked. Correspondingly, the metadata governance 304 appends the metadata file with rules, when executed, does not request param1 612 if param2 616 was not requested.

Back to FIG. 3, deployment module 306 validates compliance of parameters received from end-user application 206. The deployment module 306 ensures the parameters received from the user-end application 206 is compliant with the parameters required to invoke the respective components of cloud platform 100. When executed, the deployment module 306 compares the parameters received from the end-user application 206 with the parameters discovered by the response received by the metadata generator 302. The deployment module 306 checks if all required parameters and their formats are provided by the end-user application 206. For example, if a component of cloud platform 100 requires a string parameter for label “user name,” the deployment module 306 ensures the end-user application 206 provides a string format parameter. Also, in another example, if a component requires a specific number of parameters, the deployment module 306 checks if the specific number of parameters is provided by the end-user application 206.

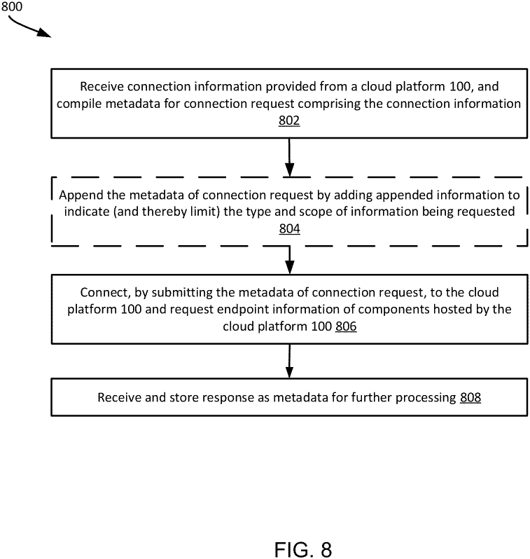

FIG. 8 is a flowchart of a method for generating metadata using the metadata generator 302 in accordance with an example embodiment of the present disclosure. The method 800 receives connection information from cloud platform 100 at block 802. It compiles metadata for a connection request and stores metadata for the connection request in data 224 (or corresponding cloud memory when the end-user application 206 hosted on application platform 106 as a cloud application 100). The connection information does not usually change. The method 800 may update the metadata of the connection request with appending information to indicate and limit the type and scope of information being requested from the cloud platform 100 at block 804. At block 806, method 800 submits to the cloud platform 100 the metadata of connection request to establish a connection with cloud platform 100. When connected successfully, the method 800 receives a response and stores it as metadata in a metadata file in data 224 (or corresponding cloud memory when the end-user application 206 hosted on application platform 106 as a cloud application 100) at block 808.

Method 800 is performed at runtime, whenever the end-user application 206 requests to integrate components. It may also be performed at any time the end-user application 206 requests to discover endpoint information of new component or update endpoint information of existing components hosted by the cloud platform 100.

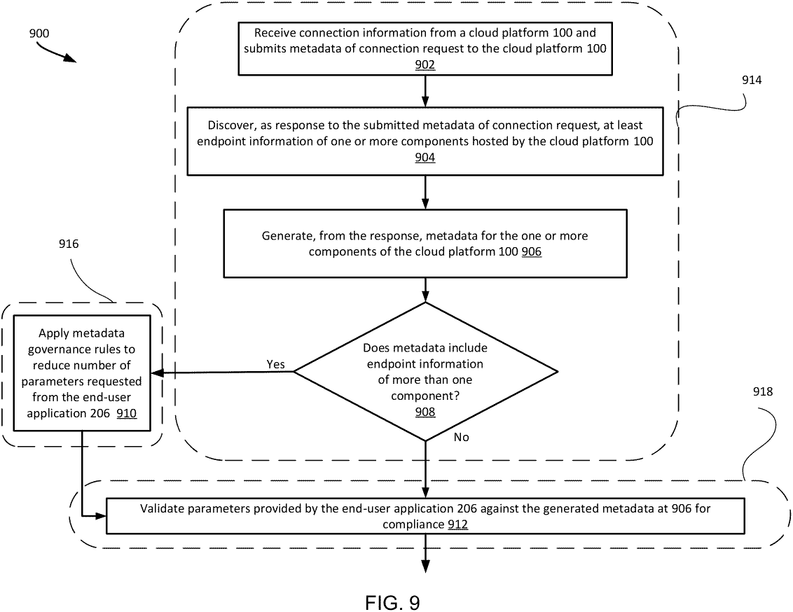

FIG. 9 is a flowchart of a method performed by an integration module 222, in accordance with an example embodiment of the present disclosure. The method 900 receives connection information provided by the cloud platform 100, generates metadata of connection request comprising the connection information, and submits the metadata of connection request to the cloud platform 100 at block 902. In response to the metadata of connection request, method 900 receives at least endpoint information of one or more components hosted by the cloud platform 100 at block 904. At block 906, the method generates metadata for each component received in the response, storing it in a metadata file in data 224 (or corresponding cloud memory when the end-user application 206 hosted on application platform 106 as a cloud application 100). If the metadata includes endpoint information for more than one component (block 908), metadata governance rules are applied to reduce the number of parameters requested from the end-user application 206 at block 910.

The metadata governance rules include, to name two rules, an override rule and a dependency rule as explained above. The metadata at this stage, after applying metadata governance rules at block 910 or if the generated metadata includes only one component at block 906, is ready for execution by the end-user application 206. At block 912, the method 900 receives the parameters provided by the end-user application 206 and validates them against the generated metadata at block 906.

Block 914 corresponds to the operation of the metadata generator 302 of the integration module 222, block 916 corresponds to the operation of the metadata governance module 304 of the integration module 222, and block 918 corresponds to the operation of the deployment module 306 of the integration module 222.

The example embodiments described above may be implemented by using hardware only or by using software and a necessary universal hardware platform. Based on such understandings, the technical solution of some example embodiments may be embodied in the form of a software product. The software product may be stored in a non-volatile or non-transitory storage medium, which can be a compact disk read-only memory (CD-ROM), Universal Serial Bus (USB) flash disk, or a removable hard disk. The software product includes a number of instructions that enable a computer device (personal computer, server, or network device) to execute the methods provided in the example embodiments. The software product may additionally include a number of instructions that enable a computer device to execute operations for configuring or programming a digital logic apparatus in accordance with example embodiments.

Example systems and methods described herein, in accordance with example embodiments, can be implemented by one or more controllers. The controllers can comprise hardware, software, or a combination of hardware and software, depending on the particular application, component or function. In some example embodiments, the one or more controllers can include analog or digital components, and can include one or more processors, one or more non-transitory storage mediums such as memory storing instructions executable by the one or more processors, one or more transceivers (or separate transmitters and receivers), one or more signal processors (analog or digital), and one or more analog circuit components.

In the described methods or block diagrams, the boxes may represent events, steps, functions, processes, modules, messages, and/or state-based operations, etc. Although some of the above examples have been described as occurring in a particular order, it will be appreciated by persons skilled in the art that some of the steps or processes may be performed in a different order provided that the result of the changed order of any given step will not prevent or impair the occurrence of subsequent steps. Furthermore, some of the messages or steps described above may be removed or combined in other embodiments, and some of the messages or steps described above may be separated into a number of sub-messages or sub-steps in other embodiments. Even further, some or all of the steps may be repeated as necessary. Elements described as methods or steps similarly apply to systems or subcomponents, and vice-versa. Reference to such words as “sending” or “receiving” could be interchanged depending on the perspective of the particular device.

The above-discussed embodiments are considered to be illustrative and not restrictive. Example embodiments described as methods would similarly apply to systems, and vice-versa.

Variations may be made to some example embodiments, which may include combinations and sub-combinations of any of the above. The example embodiments presented above are merely examples and are in no way meant to limit the scope of this disclosure. Variations of the innovations described herein will be apparent to persons of ordinary skill in the art, such variations being within the intended scope of the present disclosure. In particular, features from one or more of the above-described embodiments may be selected to create alternative embodiments comprised of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the present disclosure as a whole. The subject matter described herein intends to include all suitable changes in technology.

What is claimed is:

1. A method for integrating one or more components of cloud computing services with an end-user application, the method comprising:
receiving connection information necessary to connect to a cloud platform, the cloud platform being an architecture hosting the cloud computing services;
requesting, at runtime by submitting the connection information to the cloud platform, endpoint information of one or more components hosted by the cloud platform;
receiving, from the cloud platform, in response to the submitted connection information, endpoint information of the one or more components hosted by the cloud platform, the endpoint information including at least parameters required to invoke the one or more components; and
generating metadata for each component of the one or more components, the metadata of each component comprising endpoint information enabling the end-user application to invoke the respective component of the cloud platform.

2. The method of claim 1, further comprising applying rules to the generated metadata to reduce the number of parameters required from the end-user application to invoke the one or more components.

3. The method of claim 2, further comprising identifying, from the generated metadata, a common label, the common label being parameters of the same label, then requesting one instance of the common label from the end-user application, wherein a rule of the rules is configured to copy data of the parameter of the one instance of the common label into all parameters of the common label.

4. The method of claim 2, further comprising identifying, from the generated metadata, dependency relationship between a first component and a second component, the first component being dependent on the second component, wherein a rule of the rules is configured to request one or more parameters from the end-user application to invoke the second component only if the one or more parameters of the first component are being requested.

5. The method of claim 1, wherein the method is repeated at any instance requested by the end-user application, generating metadata and discovering endpoint information changes of the one or more components.

6. The method of claim 1, wherein the connection information are submitted with appending information to indicate and thereby limit the type and scope of information being requested.

7. The method of claim 1, wherein the end-user application using the method is a cloud platform application.

8. The method of claim 1, wherein the end-user application using the method is an on-premise application in a processing device.

9. The method of claim 1, further comprising requesting from the end-user application the parameters detailed in the generated metadata to invoke the respective one or more components, then validating the parameters received from the end-user application against the generated metadata for compliance.

10. The method of claim 1, wherein the generated metadata is organized in JavaScript Object Notation (JSON) format.

11. A computing system for integrating one or more components of cloud computing services with an end-user application, the computing system comprising:
a processor configured to:
receive connection information necessary to connect to a cloud platform, the cloud platform being an architecture hosting the cloud computing services;
request, at runtime by submitting the connection information to the cloud platform, endpoint information of one or more components hosted by the cloud platform;
receive, from the cloud platform, in response to the submitted connection information, endpoint information of the one or more components hosted by the cloud platform, the endpoint information including at least parameters required to invoke the one or more components; and
generate metadata for each component of the one or more components, the metadata of each component comprising endpoint information enabling the end-user application to invoke the respective component of the cloud platform.

12. The system of claim 11, wherein the processor is further configured to apply rules to the generated metadata to reduce the number of parameters required from the end-user application to invoke the one or more components.

13. The system of claim 12, wherein the processor is further configured to identify, from the generated metadata, a common label, the common label being parameters of the same label, then request one instance of the common label from the end-user application, wherein a rule of the rules is configured to copy data of the parameter of the one instance of the common label into all parameters of the common label.

14. The system of claim 12, wherein the processor is further configured to identify, from the generated metadata, dependency relationship between a first component and a second component, the first component being dependent on the second component, wherein a rule of the rules is configured to request one or more parameters from the end-user application to invoke the second component only if the one or more parameters of the first component are being requested.

15. The system of claim 11, wherein the processor is configured to repeat operations at any instance requested by the end-user application, generating metadata and discovering endpoint information changes of the one or more components.

16. The system of claim 11, wherein the processor is configured to submit appending information with the connection information to indicate (and thereby limit) the type and scope of information being requested.

17. The system of claim 11, wherein the end-user application using the system is an on-premise application in a processing device.

18. The system of claim 11, wherein the processor is further configured to request from the end-user application the parameters detailed in the generated metadata to invoke the respective one or more components, then validating the parameters received from the end-user application against the generated metadata for compliance.

19. The system of claim 11, wherein the processor is configured to organize the generated metadata in JavaScript Object Notation (JSON) format.

20. A non-transitory computer-readable medium which stores instructions that,
when executed by one or more processors, causes the one or more processors to perform a method of integrating one or more components of cloud computing services with an end-user application, comprising:
receiving connection information necessary to connect to a cloud platform, the cloud platform being an architecture hosting the cloud computing services;
requesting, at runtime by submitting the connection information to the cloud platform, endpoint information of one or more components hosted by the cloud platform;
receiving, from the cloud platform, in response to the submitted connection information, endpoint information of the one or more components hosted by the cloud platform, the endpoint information including at least parameters required to invoke the one or more components; and
generating metadata for each component of the one or more components, the metadata of each component comprising endpoint information enabling the end-user application to invoke the respective component of the cloud platform.
